(19) United States
(12) Patent Application Publication
(10) Pub. No.: US 2005/0242625 A1
(43) Pub. Date: Nov. 3, 2005

(54) Sidewall module of a motor vehicle

(75) Inventors: Udo Hafner, Muenchen (DE); Mario Leitner, Vierkirchen (DE); Stefan Adler, Muenchen (DE); Niklas Eberle, Muenchen (DE); Dirk Hachmann, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke AG, Muenchen (DE)

(21) Appl. No.: 11/111,865

(22) Filed: Apr. 22, 2005

Related U.S. Application Data
(63) Continuation of application No. PCT/EP03/09844, filed on Sep. 5, 2003.

(30) Foreign Application Priority Data
Oct. 22, 2002 (DE) 102 49 115.1

(51) Int. Cl. B62D 25/02

(52) U.S. Cl. 296/193.05

(57) ABSTRACT

A sidewall module of a motor vehicle in which a mounting beam which can be attached to the vehicle is preassembled with a self-supporting sidewall, and additional components may be installed in the sidewall module prior to assembly of the module on the vehicle. This approach to vehicle assembly creates a sidewall module that makes it possible to effectively utilize the construction space between the sidewall and the wheel house. Preferably, the mounting beam and the side wall are made of plastics, and the sidewall module is mounted on vehicle support structure arranged to permit the sidewall module to absorb energy in a collision with a pedestrian.

This application is a continuation of International Patent Application No. PCT/EP2003/009844, filed Sep. 5, 2003, the entire disclosure of which is incorporated herein by reference. Priority is claimed based on German Patent Application No. 102 49 115.1, filed Oct. 22, 2002.

### BACKGROUND AND SUMMARY OF THE INVENTION

This invention relates to a side wall module of a motor vehicle.

European Patent 0 839 704 B1 describes a supporting beam for vehicle body elements intended for mounting on the chassis of a motor vehicle. The supporting beam has a reinforcement on the side of the body element, the outside contour of this reinforcement being suitable for adaptation essentially to the internal shape of the vehicle body element in order to support it.

Furthermore, a vehicle body having a side wall made of plastic is known from DE 30 02 280 C2. The side wall is attached by screws to a beam system situated above the wheel. It is a disadvantage here that the clearance between the side wall and the wheel house is utilized very little or not at all as construction space.

The object of this invention is to create a side wall and/or a side wall module which will make it possible to effectively utilize the construction space between the side wall and the wheel house.

According to this invention, a side wall module of a motor vehicle consists of at least one mounting beam with which the side wall module can be attached to the motor vehicle and a side wall connected thereto. The side wall is self-supporting and the mounting bean is used only for fastening and not for large-area support of the side wall. The side wall module can be preassembled for mounting on the motor vehicle. The side wall intended here is also frequently referred to in general usage as a fender.

Construction parts which have previously been mounted on the vehicle online in the actual vehicle assembly can be attached to the side wall module as part of preassembly on the mounting beam. For example, a wheel house lining may additionally be attached to the mounting beam. Other components such as headlights, flashing lights, windshield wiper fluid container, coolant equalizing containers, etc. can also be attached to the mounting beam in preassembly.

Thus previously unused construction space or space that is difficult to access on the vehicle can be filled with additional components. Since the side wall is self-supporting, the construction space is not wasted, as is the case with the supporting beams known from EP 0 839 704 B1 to support the side wall over its entire contour. At the same time, the extent of assembly in the actual automotive assembly can be reduced. It is now necessary only to attach the completed side wall module to the vehicle and establish all the required media connections. Due to the more effective utilization of the available construction space, there is the possibility of reducing the height of the engine space package and expanding it in the width of the vehicle.

The side wall is preferably connected only to the upper area of the mounting beam in its upper area (the upper area of the side wall) which is adjacent to a front flap (also known as a hood). Therefore the mounting beam can be kept narrow and small accordingly so that it requires only a small amount of construction space. The mounting beam advantageously rests with its lower area at least partially on a part of the vehicle body. This part of the vehicle body may be a chassis beam in the engine space, for example. Thus an accurate positioning of the side wall in relation to the vehicle body and thus to other components connected to the vehicle body is possible. Ideally the mounting beam has an elongated shape extending mainly in the longitudinal direction of the vehicle by analogy with the side wall. The mounting beam preferably extends over large parts of the longitudinal extent of the side wall. This ensures optimum fastening of the self-supporting side wall.

The mounting beam advantageously is made at least in part of plastic, e.g., a fiber-reinforced polyamide or polypropylene. Therefore the mounting beam can be designed relatively freely and has a low weight in comparison with other materials. Furthermore the plastic is very corrosion-resistant. A hybrid design in which the mounting beam is made partially of plastic and partially of metallic materials is also conceivable. The mounting beam may also be designed in one or more parts. Therefore, the rigidity of the mounting beam may be designed to do justice to requirements in different directions because additional ribs and reinforcements can be produced with no problem.

The rigidity and/or the shape of the mounting beam is/are advantageously adjustable so as to achieve a targeted flexibility in the event of a collision with a pedestrian. The mounting beam may therefore have at least one upper chassis beam and one lower chassis beam, for example, interconnected by S-shaped webs. In the event of a pedestrian collision with the side wall, the impact forces are introduced into the upper chassis beam because the side wall is connected to the upper chassis beam. The lower chassis beam rests on a component of the vehicle body. Due to the impact forces, the upper chassis beam is forced down toward the lower chassis beam. In doing so the S-shaped webs undergo plastic deformation until the upper chassis beam rests on the lower chassis beam and/or on the completely collapsed webs on the block. Due to the plastic deformation, the impact energy is at least partially absorbed. The plastic deformation is also influenced to a significant extent by the properties of the material such as the rigidity of the mounting beam.

The side wall is advantageously made of plastic. This allows a greater design freedom in comparison with sheet metal components because it is also possible to produce undercuts, and yield limits are no obstacle in shaping.

The side wall module advantageously also has at least one reinforcing rib. The reinforcing rib increases the rigidity of the side wall module. It may be designed as a separate component or designed in one piece with the mounting beam and/or with the side wall.

In addition to the inventive side wall module, front-end modules including at least a bumper with a liner and optionally with flashing lights, etc. are already known in general. Such a front-end module is described in DE 198 56 350 A1, for example. In an advantageous embodiment of this invention, right and left side wall modules at the front are connected to one another and to a front-end module and together form a preassembly unit.

For attaching such a side wall module or preassembly unit, the front-end structure of the vehicle may also be designed differently than is necessary for a traditional assembly of all individual parts. Ideally, the side wall module and/or the preassembly unit may be attached to a beam which extends from the A pillar to a spring support and then ends in an acute angle in an engine mount. The beam advantageously runs in the area between the spring support and the opening into the engine mount practically above the engine mount without any lateral offset. To accommodate the side wall module or the preassembly unit, no additional supporting beams are necessary such as those that would be arranged above a wheel, for example, and are cantilevered freely toward the front. The side wall module and/or the preassembly unit may be attached to the vehicle exclusively on the beam, on the A pillar and/or on the engine mount.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a perspective exploded diagram of a side wall module in accordance with an embodiment of the present invention,

FIG. 2 shows a perspective view of the side wall module of FIG. 1,

FIG. 3 shows another perspective view of the side wall module from FIG. 1,

FIG. 4 shows a perspective view of a preassembly unit in accordance with an embodiment of the present invention,

FIG. 5 shows a side view of a front-end structure, in accordance with an embodiment of the present invention

FIG. 6 shows a perspective view of the front-end structure from FIG. 5,

FIG. 7 shows a top view of the front-end structure from FIG. 5,

FIG. 8 shows a perspective view of possible joint lines between a side wall in accordance with an embodiment of the present invention module and an adjacent engine hood, and

FIG. 9 shows a top view of the possible joint lines from FIG. 8.

### DETAILED DESCRIPTION

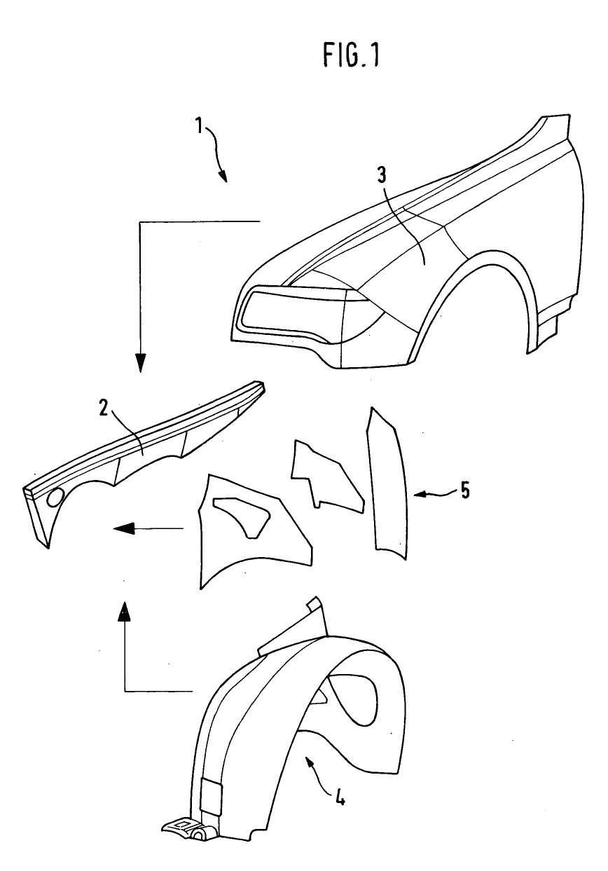

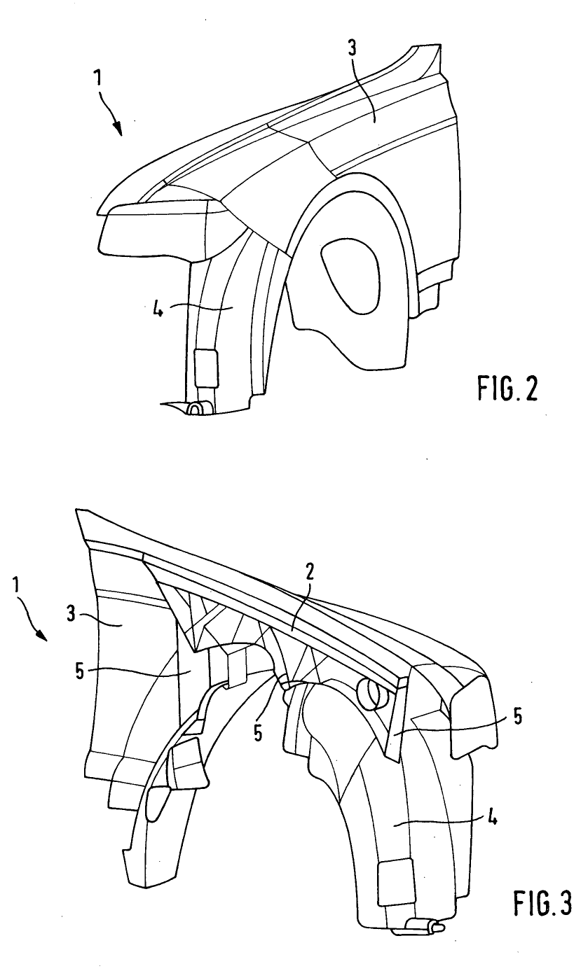

FIG. 1, FIG. 2 and FIG. 3 each show a side wall module 1. The side wall module 1 consists of a mounting beam 2 made of plastic, a self-supporting side wall 3 made of plastic, a wheel house lining 4 and several additional reinforcing ribs 5. The mounting beam 2 is provided with ribs and has an elongated shape extending in the longitudinal direction of the vehicle and approximately over the entire length of the side wall module 1. The mounting beam 2 is connected only at its top to the upper area of the side wall 3, which is adjacent to a front flap. The reinforcing ribs 5 run at a distance of approximately 5 mm from the side wall 3 and are interconnected with a strap which secures the reinforcing ribs 5 to one another. The reinforcing ribs 5 are for cost reasons clipped or bolted to the base body of the mounting beam 2. This simplifies the mold for manufacturing the mounting beam 2. Due to the reinforcing ribs 5, the side wall 3 is supported in lateral loads, e.g., when a person leans against it or when there is a slight lateral impact.

The side wall module 1 is completely preassembled before being mounted on the actual vehicle. This increases the utilization of the available construction space because the construction space on the side wall module 1 between the side wall 3 and the wheel house lining 4, for example, is still readily accessible, whereas the same construction space is practically inaccessible after assembly on the actual vehicle.

When repairs are necessary, it is possible to dismantle either only the wheel house lining 4 or the wheel house lining 4 and the side wall 3 or the entire side wall module 1.

The rigidity and shape of the mounting beam 2 may be intentionally kept so that the side wall 3 can yield in a defined manner when a pedestrian or a cyclist strikes the side wall 3 with his head. The low rigidity of the mounting beam 2 may be ensured, e.g., by providing recesses, by eliminating ribs or by having lower material thicknesses locally. Furthermore it is also readily possible on the side wall module 1 to adjust the flexibility for a head impact and the flexibility for impact with a person's upper leg in the area of a headlight.

Due to the use of plastic as the material for both the mounting beam 2 and also for the sidewall 3, the weight of the vehicle is reduced in comparison with that of a conventional vehicle with a side wall made of sheet metal. Thus the side wall module 1 contributes to greater driving dynamics and lower fuel consumption.

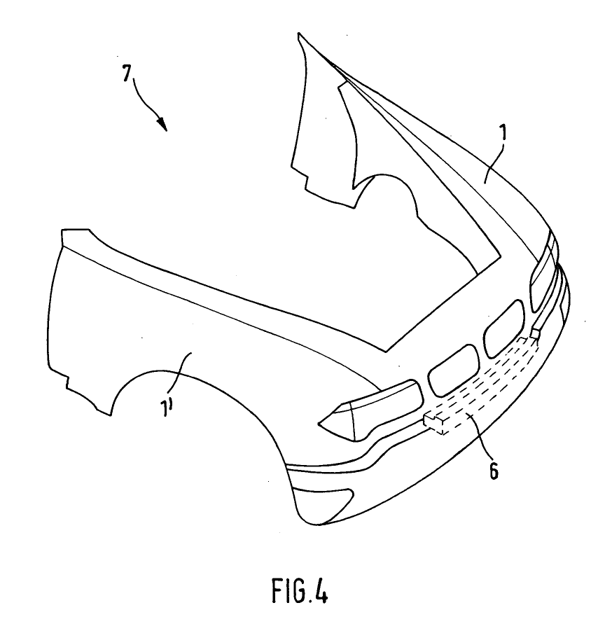

FIG. 4 shows two side wall modules 1 and 1′ with a front-end module 6 joined together to form a large preassembly unit 7. This further increases the extent of preassembly while reducing the extent of final assembly on the actual vehicle. The side wall modules 1 and 1′ need no longer be aligned with the front-end module 6 to fit together on the vehicle.

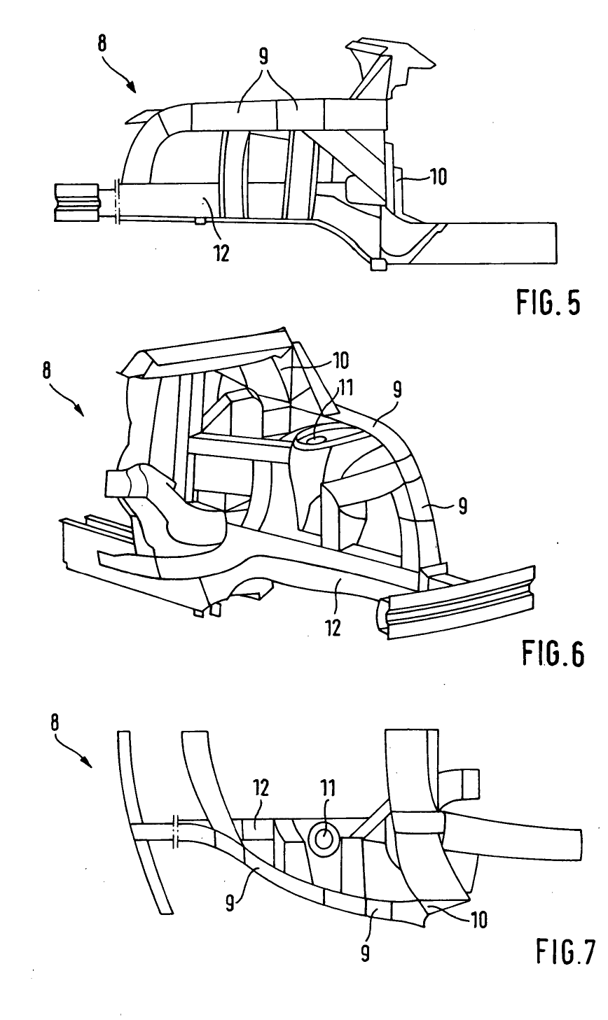

The side wall module 1 and/or the preassembly unit 7 are fastened to a front-end structure 8 of the vehicle as depicted in FIG. 5, FIG. 6 and FIG. 7. The front-end structure 8 has a beam 9 which runs from an A pillar 10 over a spring leg receptacle 11 and finally ends in an engine mount 12 in an acute angle. In contrast with conventional front-end structures 8, the beam 9 here runs in the area between the opening into the engine mount 12 and the spring leg receptacle 11 without any lateral offset above the engine mount 12. The front-end structure 8 does not have any supporting beam which lies above the wheel and protrudes freely forward from the spring leg receptacle 11. The side wall module 1 and/or the preassembly unit 7 is/are attached only to the beam 9. To do so, the mounting beams 2 each rest with their underside on the beam 9 and are attached to it.

Due to the elimination of supporting beams which are situated above the wheel and are cantilevered freely forward, there is no rigid understructure just beneath the side wall and/or a front flap. Due to the clearance, a passive pedestrian impact protection is also possible in which the side wall 3 and/or the front flap can yield accordingly in the event of impact with a pedestrian or a cyclist.

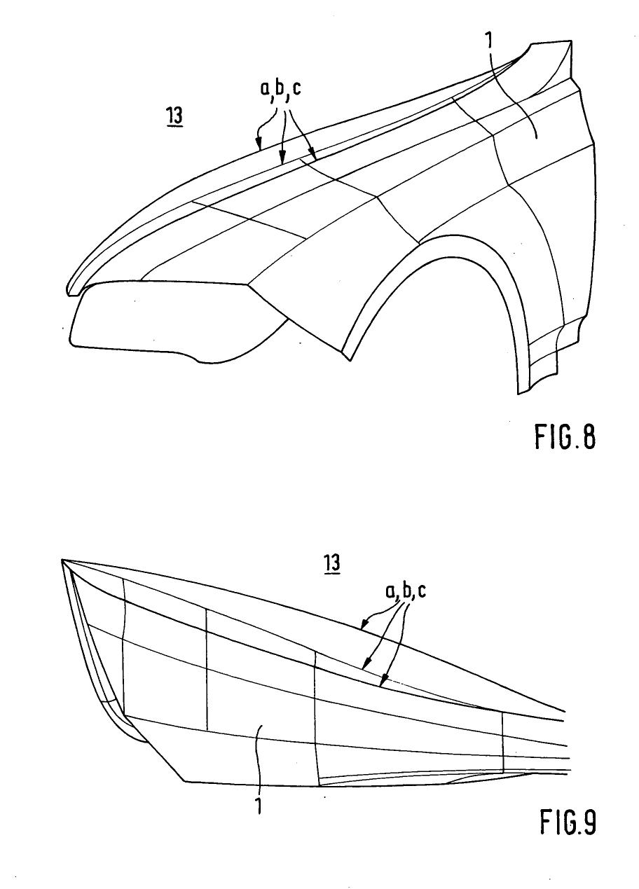

The front-end structure 8 with the large clearance additionally permits easy differentiation of vehicles. Thus different side wall modules 1 and different front flaps 13 may be mounted on the same front-end structure 8, as shown in FIG. 8 and FIG. 9. The different side wall modules 1 and front flaps 13 may have different joint lines a, b, c. The front end may also have different dimensions in height and width through appropriate adjustments in the side wall modules 1 and the front flaps 13 without having to alter the front-end structure 8.

This ease of variability of the visual appearance of a vehicle is advantageous in particular in revising models, for differentiation within a product family and for design changes within the series development process.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Side wall module of a motor vehicle comprising at least a mounting beam to which the side module can be mounted on the vehicle and a side wall connected thereto, wherein the side wall is self-supporting and the mounting beam serves only for fastening and not for area support of the side wall.

2. Side wall module as claimed in claim 1, wherein the side wall is connected to the upper area of the mounting beam only in an upper area adjacent to a front flap edge of the side wall.

3. Side wall module as claimed in claim 2, wherein the mounting beam is configured to rest with its lower area at least partially on a part of the vehicle body.

4. Side wall module as claimed in claim 1, where the mounting beam is made at least partially of plastic.

5. Side wall module as claimed in claim 1, wherein the mounting beam has an elongated shape which extends mainly in the longitudinal direction of the vehicle.

6. Side wall module as claimed in claim 5, wherein the mounting beam extends over large portions of the longitudinal extent of the side wall module.

7. Side wall module as claimed in claim 1, wherein at least one of the rigidity and shape of the mounting beam is adjusted to achieve a targeted flexibility in the event of a collision with a pedestrian.

8. Side wall module as claimed in claim 7, wherein the mounting beam has at least one upper chassis beam and one lower chassis beam which are joined together with S-shaped webs.

9. Side wall module as claimed in claim 1, wherein the mounting beam is adapted to have at least one additional component fastened thereon.

10. Side wall module as claimed in claim 9, wherein a wheel house lining is attached to the mounting beam.

11. Side wall module as claimed in claim 9, wherein the at least one additional component is one of a headlight, a flashing light, a windshield wiper fluid container and a coolant equalizing container.

12. Side wall module as claimed in claim 1, wherein the mounting beam comprises one or more parts.

13. Side wall module as claimed in claim 1, wherein the side wall is made of plastic.

14. Side wall module as claimed in claim 1, further comprising at least one reinforcing rib for reinforcing the side wall.

15. Preassembly unit comprising a right and left side wall module as claimed in claim 1, each side wall module, joined together at respective front ends with a front-end module.

16. Front-end structure of a motor vehicle for accommodating at least one side wall module as claimed in claim 1, wherein each side wall module is attached to a beam which extends from an A pillar to a spring support and then ends in an engine mount at an angle less than or equal to 90°.

17. Front-end structure of a motor vehicle for accommodating a preassembly unit as claimed in claim 15, wherein the preassembly unit is attached to a beam which extends from an A pillar to a spring support and then ends in an engine mount at an angle less than or equal to 90°.

18. Front-end structure as claimed in claim 16, wherein each beam runs above the engine mount in the area between the spring support and opening into the engine mount with essentially no lateral offset with respect to the engine mount.

19. Front-end structure as claimed in claim 17, wherein each beam runs above the engine mount in the area between the spring support and opening into the engine mount with essentially no lateral offset with respect to the engine mount.

20. Front-end structure as claimed in claim 16, wherein the front-end structure does not have any additional supporting beams for accommodation of the side wall modules.

21. Front-end structure as claimed in claim 17, wherein the front-end structure does not have any additional supporting beams for accommodation of the preassembly unit.

22. Front-end structure as claimed in claim 16, wherein each side wall module is attached to the vehicle only on at least one of its beam, the A pillar and the engine mount.

23. Front-end structure as claimed in claim 17, wherein the preassembly unit is attached to the vehicle only on at least one of its beam, the A pillar and the engine mount.

24. A method of constructing a side wall module for a motor vehicle, comprising the steps of:
providing a mounting beam and a structurally self-supporting side wall; and
prior to assembly to the motor vehicle, connecting the side wall to mounting beam at an upper front flap edge of the side wall, such that the mounting beam provides support for fastening of the side wall, without providing side wall area structural support.

25. The method of claim 24, further comprising the steps of:
attaching reinforcing ribs to the mounting beam prior to connecting the side wall to the mounting beam; and
prior to assembly to the motor vehicle, attaching to the mounting beam at least one of a wheel house lining, a headlight, a flashing light, a windshield wiper fluid container and a coolant equalizing container.

26. The method of claim 25, wherein the mounting beam is made from plastic.

27. A method of constructing a front end preassembly unit for a motor vehicle, comprising the steps of:
providing right and left side wall modules as claimed in claim 1 and a front end module; and
prior to assembly to the motor vehicle, connecting respective front ends of the side wall modules to the front end module.

28. A method for constructing a front end structure of a motor vehicle, comprising the steps of:
providing right and left side wall modules as claimed in claim 11 and right and left beams, each beam extending from an A pillar to a spring support and then to an engine mount at an angle less than or equal to 90°; and
attaching each side wall module to its respective beam only on at least one of the beam, the A pillar and the engine mount.

29. A method for constructing a front end structure of a motor vehicle, comprising the steps of:
providing front end preassembly unit as claimed in claim 15 and right and left beams, each beam extending from an A pillar to a spring support and then to an engine mount at an angle less than or equal to 90°; and
attaching each side wall module of the preassembly unit to its respective beam only on at least one of the beam, the A pillar and the engine mount.
